(19) United States
(12) Patent Application Publication
(10) Pub. No.: US 2025/0250933 A1
(43) Pub. Date: Aug. 7, 2025

(54) SOUND ABSORBER AND METHOD FOR PRODUCING SAME

(71) Applicant: SAFRAN AIRCRAFT ENGINES, Paris (FR)

(72) Inventors: Josué COSTA BAPTISTA, Montréal (CA); Edith-Roland FOTSING, Mascouche (CA); Annie ROSS, Saint Lazare (CA); Jacky Novi MARDJONO, Moissy-Cramayel (FR); Daniel THERRIAULT, Saint-Laurent (CA)

(73) Assignee: SAFRAN AIRCRAFT ENGINES, Paris (FR)

(21) Appl. No.: 18/856,425

(22) PCT Filed: Apr. 13, 2023
(86) PCT No.: PCT/FR2023/050534

§ 371 Date: Nov. 8, 2024

(30) Foreign Application Priority Data
Apr. 13, 2022 (CA) 3155206

(51) Int. Cl. F02C 7/045; B33Y 80/00; F02K 1/82; G10K 11/172

(52) U.S. Cl. CPC F02C 7/045; B33Y 80/00; F02K 1/827; G10K 11/172

(57) ABSTRACT

A sound absorber extending between two opposite surfaces, and combining one or more quarter-wave acoustic resonators, with a microporous element. Each acoustic resonator, has a length L, which is substantially greater than a thickness t of the sound absorber, between a first open end on a first surface of the two opposite surfaces, of the sound absorber and a second closed end. The microporous element is made up of a plurality of periodically repeating unit cells adjacent to the acoustic resonators. A method for producing this sound absorber, which method includes at least one additive manufacturing step.

### TECHNICAL FIELD

The present invention relates to the field of sound absorbers, as well as to that of their production.

### PRIOR ART

Sound absorbers have a wide range of applications. These include, in particular, aeronautics, where such elements are used to at least partially absorb the noise generated by aircraft engines and thus to reduce its transmission to the external environment. The most common aircraft engines include turbofans. A turbofan engine comprises a fan and a gas generator incorporating at least a compressor, a combustion chamber, a turbine and a nozzle. The total noise produced by such a turbofan engine can therefore comprise noise of the jet, combustion, fan, compressor and turbine. However, the most dominant noise is generally that emitted by the fan, which can extend over a large frequency band, as illustrated in FIG. 13, with tonal components corresponding to the frequency of passage of the fan blades. In order to increase the energy efficiency of turbofan engines, the general tendency is to increase their bypass ratio, in other words the proportion of the air flow driven by the fan compared to that used for combustion in the gas generator, and therefore the diameter of the fan. Consequently, the fans of the latest generations of turbofan engines tend to turn more slowly, and therefore to emit noise at lower frequencies.

In order to reduce the noise emitted by aircraft engines, it is therefore common to cover certain zones, such as the nacelles containing these engines, with sound absorbers such as honeycomb sandwich panels. In this type of sound absorber, each cell of the honeycomb can function as a Helmholtz resonator, in order to attenuate the noise. However, the frequency range of acoustic attenuation of such absorbers is limited and, in order to be effective at low frequencies, it must be particularly bulky, which is even more penalising since the surface to be covered can be very large for turbofan engines with very high bypass ratios.

As an alternative to honeycomb sandwich panels, it has therefore been proposed to use porous materials, the individual pores of which act as Helmholtz resonators. However, the majority of the available porous materials have too low a mechanical strength, while the strongest, such as the metal material disclosed in U.S. Pat. No. 7,963,364 B2, are excessively heavy. Moreover, these materials mostly consist of a structure with interconnected pores, which in the case of application in aircraft engines, can disturb the air flow in the engine and thus degrade the engine efficiency. In addition to these disadvantages, the minimum frequency for perfect absorption of the porous materials is generally attained when their thickness is approximately equal to a quarter of the acoustic wavelength. Consequently, in order to obtain a high absorption of noise at 1000 or 500 Hz, for example, this thickness must be approximately 86 or 171 mm respectively, resulting in many elements which are too bulky for an increasingly restrained space in the new generations of engines with a high or ultra-high bypass ratio.

The use of additive manufacturing has been proposed by Z. Liu, J. Zhan, M. Fard, and J. L. Davy in “Acoustic properties of a porous polycarbonate material produced by additive manufacturing”, Materials Letters, vol. 181, pp. 296-299, (October 2016) for producing sound absorbers comprising microchannels. However, these sound absorbers only have a very narrow range of absorption frequencies.

It has also been proposed, for example by Qian, Y. J., Kong, D. Y., Liu, S. M., Sun, S. M., & Zhao, Z., in “Investigation on micro-perforated panel absorber with ultra-micro perforations”, Applied Acoustics, 74(7), pp; 931-935 (2013), to use micro-perforated panels as sound absorbers. In order to broaden the range of acoustic absorption frequencies, Liu, Z., Zhan, J., Fard, M., & Davy, J., in “Acoustic properties of multilayer sound absorbers with a 3D printed micro-perforated panel”. Applied Acoustics, 121, pp. 25-32 (2017), and Yang, W., Bai, X., Zhu, W., Kiran, R., An, J., Chua, C. K., & Zhou, K. in “3D Printing of Polymeric Multi-Layer Micro-Perforated Panels for Tunable Wideband Sound Absorption”. Polymers, 12(2), p. 360 (2020) have also proposed superposing a plurality of these panels and producing them by additive manufacturing. However, these relatively fragile sound absorbers appear difficult to apply in environments in which they will be subject to abrasion or other mechanical stresses, such as aviation engine nacelles.

Acoustic meta-materials with a plurality of layers superposed in the direction of the thickness, produced by additive manufacturing, have been proposed in the French patent application publication FR 1 761 722, as well as by Guild, M. D., Rohde, C., Rothko, M. C., & Sieck, C. F. in “3D printed acoustic metamaterial sound absorbers using functionally-graded sonic crystals”, Proceedings of Euronoise (2018). The term “acoustic metamaterial” can be understood as a periodically structured medium, the periodically repeated constituent units of which collectively affect the passage of acoustic waves. In the case of the above-mentioned metamaterials, each superposed layer can have a lattice with a different periodicity, so as to broaden its attenuation frequency range. However, their sound absorption is reduced more at lower frequencies, which are particularly suitable for absorption in the context of fan engines with very high bypass ratios.

### Disclosure of the Invention

The present disclosure aims to overcome these disadvantages by proposing a sound absorber of small size but with good acoustic absorption properties, including at low frequencies. According to a first aspect, this sound absorber may extend between two opposite surfaces and comprise one or more first quarter-wave acoustic resonators each having a first length, substantially greater than a thickness of the sound absorber between the two opposite surfaces, between a first end, open on a first surface of the two opposite surfaces of the sound absorber, and a second, closed end, and a microporous element, consisting of a plurality of periodically repeating unit cells, adjacent to the first acoustic resonators. Through the combination of different structures from the acoustic point of view, the absorber is capable of providing high sound absorption over a wide range of frequencies.

According to a second aspect, in order to obtain a length substantially greater than the thickness of the sound absorber, the first quarter-wave acoustic resonators may be inclined relative to a direction of the thickness of the sound absorber. In particular, the first quarter-wave acoustic resonators may be at least partially helical, so as to limit their size in the direction perpendicular to the thickness. Alternatively or in addition to their inclination relative to the thickness direction, the first quarter-wave acoustic resonators may be bent.

According to a third aspect, the microporous element may comprise at least a first and a second superposed layer in the thickness of the sound absorber, and the unit cells constituting the first layer may be different from the unit cells constituting the second layer, so as to adjust the acoustic properties of the microporous element.

According to a fourth aspect, each unit cell may comprise a channel and/or intersecting strands. The microporous element may take the form of an assembly of micro-channels or a micro-lattice.

According to a fifth aspect, the first quarter-wave acoustic resonators may be disposed around the microporous element. Thus, their walls may confine the microporous element, so as to limit the circulation of acoustic waves therebeyond, in particular when the microporous element takes the form of a micro-lattice with micropores interconnected in the direction perpendicular to the thickness of the sound absorber.

According to a sixth aspect, the sound absorber may comprise one or more second quarter-wave acoustic resonators each having a second length, substantially different from the first length, in order to absorb the acoustic energy over two essentially different wavelengths. The first acoustic resonators and the second acoustic resonators may be disposed in adjacent rows, which may in particular be concentric.

A seventh and an eighth aspect concern, respectively, a gas turbine engine and an aircraft incorporating a sound absorber according to any one of the preceding aspects.

A ninth aspect concerns a method for producing a sound absorber according to any one of the first to sixth aspects, comprising a step of additive manufacturing of the microporous element and/or of the quarter-wave acoustic resonators, in particular by depositing molten material, which can be carried out, in particular, following a zig-zag path in order to limit the fluid communication between adjacent unit cells of the microporous element, between adjacent quarter-wave acoustic resonators and/or between the microporous element and the quarter-wave acoustic resonators.

According to a tenth aspect, the method may comprise a subsequent step of assembling the microporous element with the quarter-wave acoustic resonators, in particular by shrink fitting. The microporous element and/or the quarter-wave acoustic resonators may thus be more easily manufactured separately, before their assembly.

### BRIEF DESCRIPTION OF THE FIGURES

FIG. 1 schematically illustrates a gas turbine engine for the propulsion of an aircraft.

FIGS. 2A and 2B show detailed views of two different types of microporous element.

FIGS. 3A and 3B are, respectively, a top view and side view of a sound absorber according to a first embodiment.

FIG. 4 illustrates a sound absorber according to a second embodiment.

FIGS. 5 to 10 are graphs illustrating the comparative acoustic responses of various embodiments.

FIGS. 11 and 12 illustrate a step of additive manufacturing from a method for manufacturing a sound absorber according to an embodiment.

FIG. 13 is a graph illustrating the frequency spectrum of the acoustic emissions of an engine such as that of FIG. 1.

### DESCRIPTION OF THE EMBODIMENTS

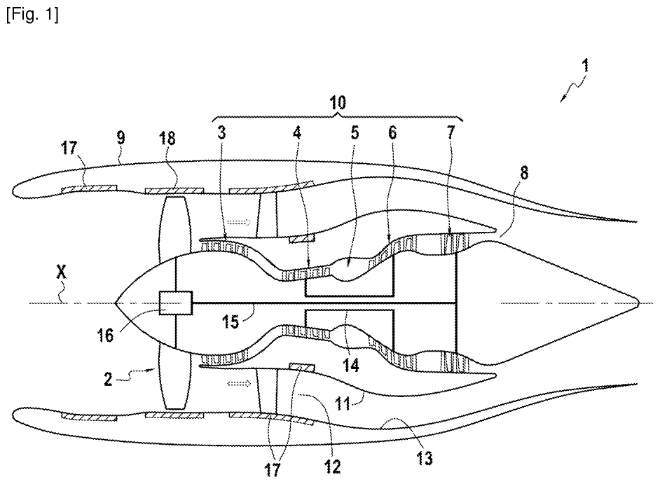

FIG. 1 schematically illustrates a gas turbine engine 1. In the direction of fluid flow, this gas turbine engine 1 can comprise a fan 2, a low-pressure compressor 3, a high-pressure compressor 4, a combustion chamber 5, a high-pressure turbine 6 and a low-pressure turbine 7 and the nozzle 8. The whole may be surrounded by a nacelle 9. The compressors 3, 4, the combustion chamber 5 and the turbines 6, 7 together form the gas generator 10, which may itself be surrounded by a fairing 11 ending in the nozzle 8. Thus, a stream of air 12 of the fan 2 may be defined between the fairing 11 of the gas generator 10 and an internal wall 13 of the nacelle 9. The high-pressure turbine 6 may be connected to the high-pressure compressor 4 by a first rotary shaft 14 for driving the latter, while the low-pressure turbine 7 may be connected to the fan 2 and to the low-pressure compressor 3 by a second rotary shaft 15 coaxial with the first rotary shaft 14, in an analogous manner. In the context of engines with high and very high bypass ratio, a reducing gear 16 may be interposed mechanically between the second rotary shaft 15 and the fan 2, in order to reduce the speed of rotation of the fan 2 and to prevent the ends of the blades of the fan 2 from attaining excessive speeds.

Each of these elements of the gas turbine engine 1 can generate noise, but the noise generated by the fan 2 is generally dominant. In addition, in engines with high and very high bypass ratio, and in particular in those equipped with a reducing gear 16, a large part of the noise of the fan 2 can be concentrated at low frequencies, as illustrated in FIG. 10, showing the sound pressure level (SPL) as a function of frequency f. In order to absorb at least a part of the noise of the fan 2, noise absorbers 17 may be incorporated in the internal wall 13 of the nacelle 9, in particular upstream and downstream of the fan blades 2. As illustrated, it is however also possible to incorporate sound absorbers 17 in the fairing 11 of the gas generator 10, or even in its casing.

Sound absorbers 17 are typically formed by honeycomb sandwich panels. However, in engines with high or very high bypass ratio, these panels can represent a significant penalty in terms of mass and size. In addition, it can be difficult to arrange them directly opposite the ends of the blades of the fan, where however the noise emission can be most intense, since the internal wall 13 of the nacelle 9 typically comprises an abradable material 18 at this location, in order to absorb the occasional rubbing of the ends of the fan blades 2 due to their transitory deformations.

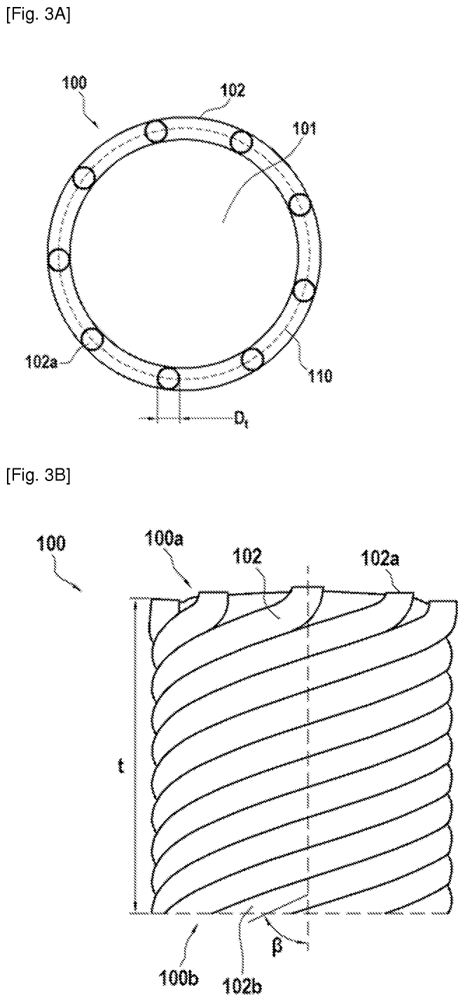

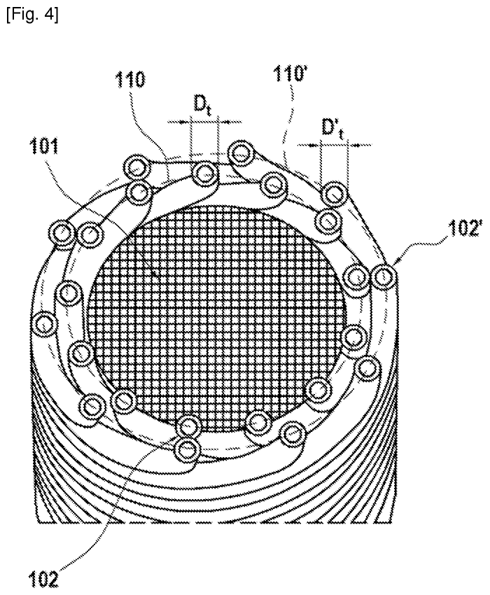

A sound absorber 100 according to an embodiment may include a microporous element 101 and one or more acoustic resonators 102, as illustrated in FIGS. 3A, 3B and 4, so as to combine their sound absorption properties over a broad spectrum of frequencies, which may include, in particular, the frequencies corresponding to the emission peaks of a gas turbine engine.

The microporous element 101 and/or the acoustic resonators 102 may be made of thermoplastic polymer, for example of polyetherimide (PEI) or polyetheretherketone (PEEK), or a thermosetting resin, for example an epoxy resin such as that forming the abradable material sold by 3M® under the name Scotch-Weld@ EC-3524 B/A. In order to reinforce this material, in particular when the sound absorber 100 is intended to be disposed opposite rotating parts, and in particular the rotating blades of a fan 2, the material may be reinforced by solid particles embedded in the mass, for example fibres, and in particular carbon fibres, microspheres, for example glass microbeads, or nanoparticles such as silica powder. Depending on the material and the reinforcements used for manufacturing the sound absorber 100, it can have a significant mechanical strength and thermal resistance as well as abradability properties.

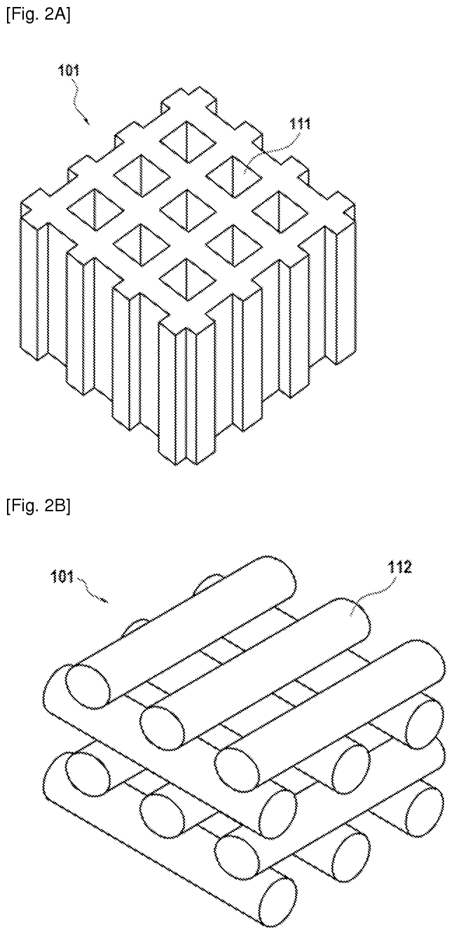

The microporous element 101 may be constituted of a plurality of periodically repeated unit cells 110, so as to form a periodic metamaterial. Each unit cell 110 may comprise a channel 111 and/or intersecting strands 112, as respectively illustrated in FIGS. 2A and 2B, so that the microporous element may respectively take the form of an assembly of microchannels or a microlattice. Furthermore, the microporous element 101 may comprise a plurality of superposed layers in the thickness of the sound absorber 100, and the different layers may consist of unit cells different from the different unit cells 110. By superposing several layers with different properties in this way, it is particularly possible to absorb acoustic energy over a broader spectrum of frequencies.

As illustrated in FIGS. 3A, 3B and 4, the acoustic resonators 102 may, in particular, take the form of tubular waveguides, with a first end 102a open, and a second end 102b closed. The sound absorber 100 may be used as a sound absorption coating on a wall (not illustrated) that is substantially impermeable to sound. In this case, the second ends 102b of the acoustic resonators 102 may be simply closed by said wall. Thus, these tubular waveguides may function as quarter-wave acoustic resonators, in order to absorb the acoustic waves of length equal to a quarter times the length of the acoustic resonator 102 between its open end 102a and its closed end 102b. In order to absorb acoustic energy over low frequencies, this length must be substantially greater than the thickness t of the sound absorber 100 between its two opposite surfaces 100a, 100b. For this purpose, the acoustic resonators 102 may be inclined at an angle β relative to the direction of the thickness of the sound absorber 100. More particularly, they may be at least partially helical, as illustrated in FIGS. 3A, 3B and 4, so as to also limit the extension in each direction perpendicular to the direction of thickness of the sound absorber 100. Alternatively, or in addition to their inclination relative to the direction of the thickness, the acoustic resonators 102 may also be bent in order to increase the ratio between their length and the thickness t of the sound absorber 100.

Furthermore, as illustrated in FIGS. 3A, 3B and 4, the acoustic resonators 102 may be disposed along a plurality of rows 110,110′. As illustrated in FIG. 3, each row 110,110′ may follow a closed line, for example a circular, oval or polygonal line. Thus, the acoustic resonators 102 may be arranged around the microporous element 101, in order to confine it. The circulation of the acoustic waves perpendicular to the thickness of the sound absorber 100 can be limited in this way, which can be particularly preferable when the microporous element 101 takes the form of a microlattice with micropores which are interconnected in the direction perpendicular to the thickness of the sound absorber 100. In addition, as illustrated in FIG. 4, when the rows 110, 110′ follow closed lines, they may in particular be concentric.

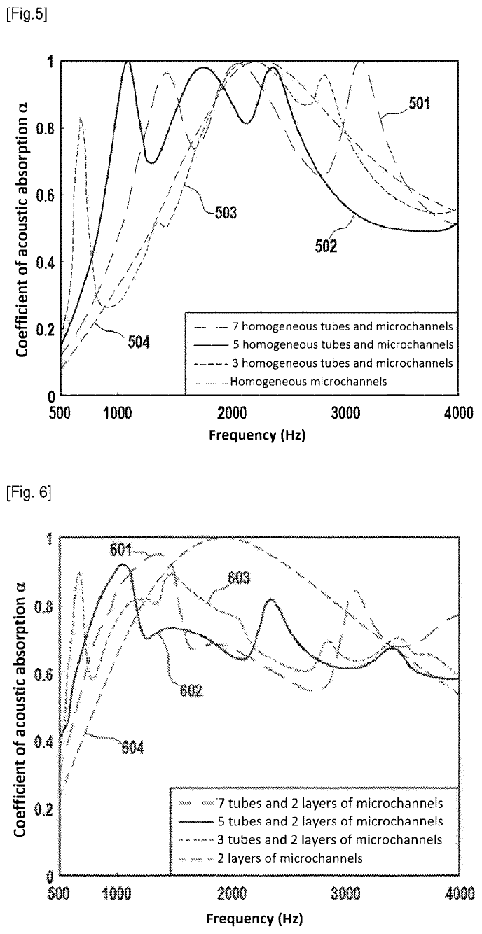

FIG. 5 illustrates in a comparative manner the respective curves of the acoustic absorption coefficient □ as a function of the frequency for samples of sound absorbers 100 having a thickness t of 30 mm and including a single-layer microporous element 101 with pores having a diameter D of 290 μm and different numbers and lengths L of acoustic resonators 102 formed by tubes, each having a diameter Dt between 3 and 5 mm, wound helically around the microporous element 101. Curve 501 corresponds to a sound absorber 100 with seven acoustic resonators 102, each forming 1.25 turns around the microporous element 101, in order to obtain a length L of each acoustic resonator 102 of 109 mm. Curve 502 corresponds to a sound absorber 100 with five acoustic resonators 102, each forming 1.75 turns around the microporous element 101, in order to obtain a length L of each acoustic resonator 102 of 150 mm. Curve 503 corresponds to a sound absorber 100 with three acoustic resonators 102, each forming three turns around the microporous element 101, in order to obtain a length L of each acoustic resonator 102 of 220 mm. By way of comparison, curve 504 corresponds to the acoustic response of the single-layer microporous element 101 alone, without a sheath of acoustic resonators. As can be seen here, the acoustic resonators 102 give additional peaks of the acoustic absorption coefficient □. More specifically, the example with seven acoustic resonators 102 gives an additional peak of the coefficient of acoustic absorption □ with a value of 0.95 at a frequency f of 1200 Hz on curve 501, the example with five acoustic resonators 102 gives an additional peak of the coefficient of acoustic absorption □ with a value of 0.92 at a frequency f of 1060 Hz on curve 502 and the example with three acoustic resonators 102 gives an additional peak of the coefficient of acoustic absorption □ with a value of 0.89 at a frequency f of 668 Hz on curve 503.

FIG. 6 illustrates comparatively the respective curves of the coefficient of acoustic absorption □ as a function of the frequency for samples of sound absorbers 100 having a thickness t of 30 mm and including a microporous element 101 with two layers and different numbers and lengths L of acoustic resonators 102 formed by tubes between 3 and 5 mm in diameter, wound helically around the microporous element 101. More specifically, the microporous element 101 comprises a first layer 101a, on the side of the first surface 100a of the sound absorber 100, with a thickness t₁ of 2 mm and a pore diameter D₁ of 100 μm, and a second layer 101b, on the side of the second surface 100b of the sound absorber 100, with a thickness t₂ of 28 mm and a pore diameter D2 of 4.6 mm. Curve 601 corresponds to a sound absorber 100 with seven acoustic resonators 102, each forming 1.25 turns around the microporous element 101, in order to obtain a length L of each acoustic resonator 102 of 109 mm. Curve 602 corresponds to a sound absorber 100 with five acoustic resonators 102, each forming 1.75 turns around the microporous element 101, in order to obtain a length L of each acoustic resonator 102 of 150 mm. Curve 603 corresponds to a sound absorber 100 with three acoustic resonators 102, each forming three turns around the microporous element 101, in order to obtain a length L of each acoustic resonator 102 of 220 mm. By way of comparison, curve 604 corresponds to the acoustic response of the microporous element 101 with two layers only, without a sheath of acoustic resonators. As can be seen here, additional peaks in the coefficient of acoustic absorption will also be found at frequencies f of 1200 Hz on curve 601, 1060 Hz on curve 602, and 668 Hz on curve 603.

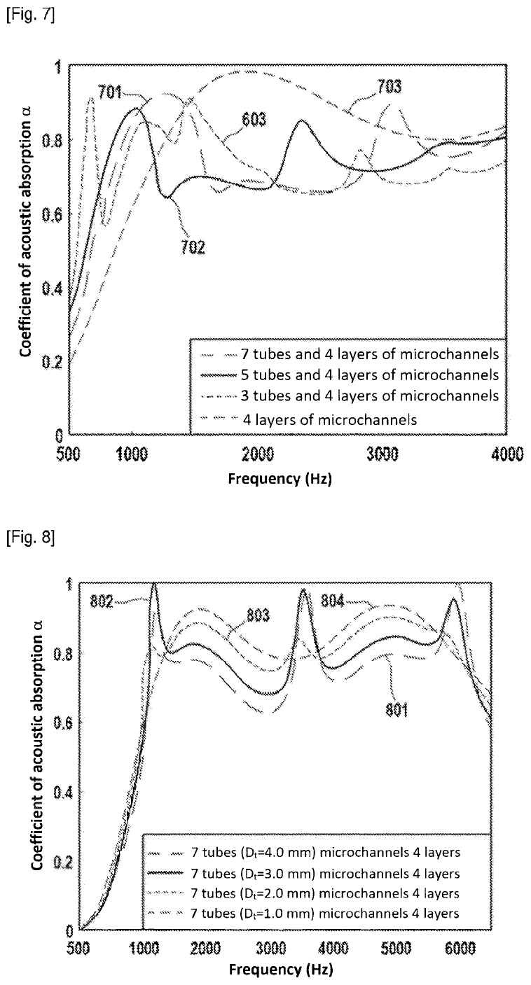

FIG. 7 illustrates comparatively the respective curves of the coefficient of acoustic absorption □ as a function of the frequency for samples of sound absorbers 100 having a thickness t of 30 mm and including a microporous element 101 with four layers and different numbers and lengths L of acoustic resonators 102 formed by tubes of between 3 and 5 mm in diameter wound helically around the microporous element 101. More specifically, the microporous element 101 comprises a first layer 101a, on the side of the first surface 100a of the sound absorber 100, with a thickness t₁ of 1 mm and a pore diameter D₁ of 100 μm and, successively towards the second surface 100b of the sound absorber 100, a second layer 101b with a thickness t₂ of 13 mm and a pore diameter D₂ of 4.6 mm, a third layer 101c with a thickness t₃ of 2 mm and a pore diameter D₃ of 100 μm, and a fourth layer 101d with a thickness t₄ of 13 mm and a pore diameter D₄ of 4.6 mm. Curve 701 corresponds to a sound absorber 100 with seven acoustic resonators 102, each forming 1.25 turns around of the microporous element 101, in order to obtain a length L of each acoustic resonator 102 of 109 mm. Curve 702 corresponds to a sound absorber 100 with five acoustic resonators 102, each forming 1.75 turns around the microporous element 101, in order to obtain a length L of each acoustic resonator 102 of 150 mm. By way of comparison, curve 703 corresponds to the acoustic response of the microporous element 101 with two layers only, without a sheath of acoustic resonators, and curve 603 is also considered, corresponding to a sound absorber 100 with three acoustic resonators 102 around the microporous element 101 with only two layers. As can be seen here, additional peaks in the coefficient of acoustic absorption will also be found at frequencies f of 1200 Hz on curve 701, and 1060 Hz on curve 702.

FIG. 8 illustrates the influence of the diameter Dₜ of the acoustic resonators on the coefficient of acoustic absorption, □. The four curves 801 to 804 correspond to a sound absorber 100 with seven acoustic resonators 102 of 109 mm length L, each forming 1.25 turns around a microporous element 101 with four layers, of which a first layer 101a, on the side of the first surface 100a of the sound absorber 100, with a thickness t₁ of 1 mm and a pore diameter D₁ of 100 μm and, successively towards the second surface 100b of the sound absorber 100, a second layer 101b with a thickness t₂ of 13 mm and a pore diameter D₂ of 4.6 mm, a third layer 101c with a thickness t₃ of 2 mm and a pore diameter D₃ of 100 μm, and a fourth layer 101d with a thickness t₄ of 13 mm and a pore diameter D₄ of 4.6 mm. However, curve 801 corresponds to a diameter D₁ of each acoustic resonator 102 of 4 mm, curve 802 to a diameter Dₜ of 3 mm, curve 803 to a diameter Dₜ of 2 mm, and curve 804 to a diameter Dₜ of 1 mm. It is therefore possible, as a function of the desired absorption spectrum, to optimise not only the configuration of the microporous element 101, and the length and number of acoustic resonators 102, but also their individual diameters.

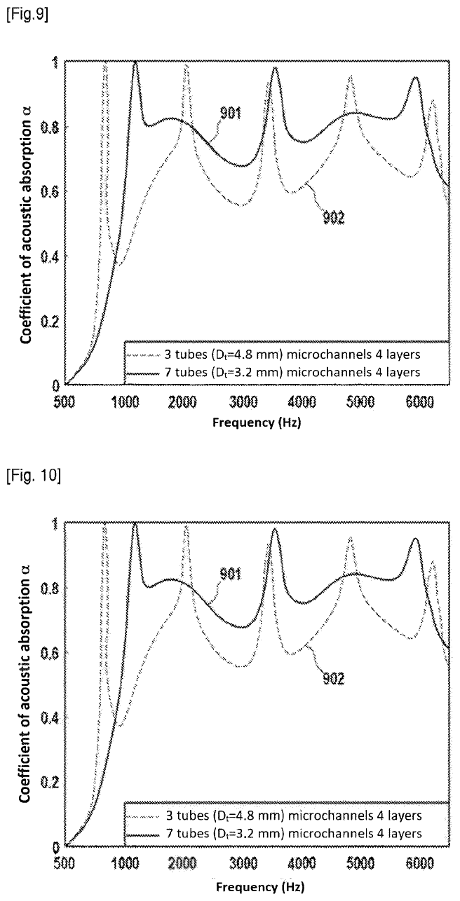

Thus, the optimum diameter Dt for the acoustic resonators 102 of a sound absorber 100 with seven acoustic resonators 102 of 109 mm length L, each forming 1.25 turns around the microporous element 101 with four layers as mentioned above, may be for example 3.2 mm, resulting in a coefficient of acoustic absorption □ as a function of the frequency f according to curve 901 of FIG. 9, while the optimum diameter Dₜ for the acoustic resonators 102 of a sound absorber 100 with the same microporous element but only three acoustic resonators 102 of 220 mm length, each forming three turns around the microporous element 101, may be for example 4.8 mm, resulting in the curve 902.

in addition as illustrated in FIG. 4, the sound absorber 100 may comprise acoustic resonators 102,102′ of different lengths, in order to absorb the acoustic energy over various wavelengths. Thus, as illustrated in FIG. 4, a first set of helical acoustic resonators 102, each having a first angle of inclination β relative to the direction of the thickness, and therefore a first length L, may be disposed along a first circular row 110, and a second set of helical acoustic resonators 102′, each having a second angle of inclination β′ relative to the direction of the thickness, and therefore a second length L′, may be disposed along a second circular row 110′ which is concentric relative to the first row 110, in such a way as to confine together the microporous element 101.

FIG. 10 thus compares curve 901 of the sound absorber 100 with seven acoustic resonators 102 of 109 mm length L around the microporous element 101 with four layers with curve 903 corresponding to a sound absorber with the same microporous element 101 with four layers, but surrounded by two concentric sheaths, respectively formed by a first and a second set of acoustic resonators 102, 102′, where the first set is formed by seven acoustic resonators 102 of 109 mm length L circularly arranged and wound around the microporous element 101, while the second set is formed by three acoustic resonators 102′ of 220 mm length circularly arranged and wound around the microporous element 101. As can be seen here, this curve 903 combines the acoustic absorption peaks of curves 901 and 902.

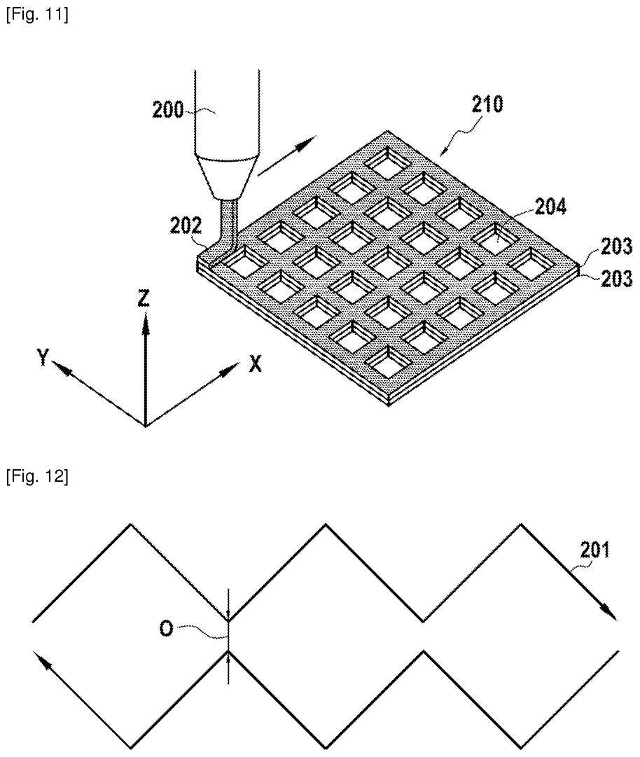

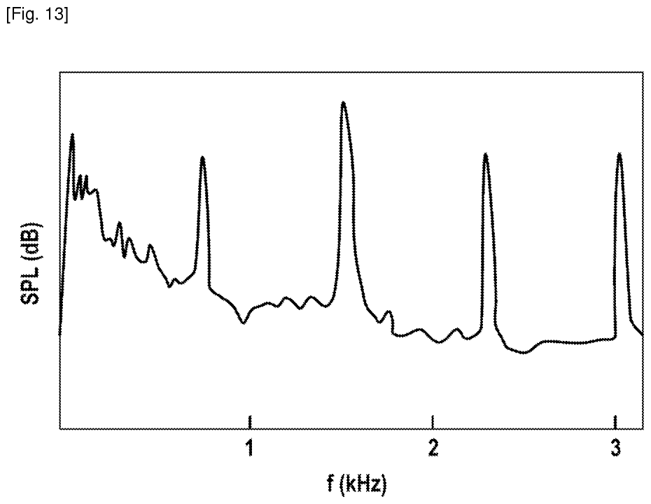

The acoustic resonators 102, 102′ and/or the microporous element 101 may be produced, together or separately, by an additive manufacturing method based on the extrusion of material, such as the method for depositing molten yarn used for thermoplastic materials. These methods, particularly suitable for the manufacture of complex shapes with thin walls, comprise a plurality of consecutive material deposition steps. In each of these steps, an extruder head 200 may move along a path 201 in a transverse plane X-Y while depositing the material 202, which then solidifies so as to form a layer 203. By moving this transverse plane X-Y in an orthogonal direction Z after the depositing of each layer 203, it is possible to stack these layers 203 in order to form the microporous element 101 and/or the acoustic resonators 102, as illustrated in FIG. 11. In order to form tubes and/or channels, each layer 203 may comprise a plurality of periodically repeated cells, separated by the walls formed by the deposition of the material 202, and the layers 203 in the consecutive material deposition steps may be stacked with their respective cells aligned.

In order to at least partially avoid the intersecting of the extruded material 202 during the deposition of a layer 203, which could cause the formation of pores between the adjacent cells, the path 201 may be a zig-zag, as illustrated in FIG. 12. In order to avoid an accumulation of material and the formation of pores at the intersections between the walls, a gap O may be maintained between the angles 205 of the path 201 at these intersections.

When the acoustic resonators 102, 102′ and the microporous element 101 are manufactured separately, they may be assembled together to form the sound absorber 100. This assembly may be carried out by shrink fitting. Thus, when the acoustic resonators 102, 102′ are deposited so as to form one or more annular sheaths, as illustrated in FIG. 3 or 4, the microporous element 101 may then be shrink fitted to the inside of these sheaths. A strong connection can thus be obtained between these sheaths of acoustic resonators 102, 102′ and the microporous element 101 to the inside, due to the radial pressure and the friction resulting between them.

Although the present invention has been described by referring to specific exemplary embodiments, it is obvious that various modifications and changes can be made to these examples without going beyond the general scope of the invention as defined by the claims. In addition, the individual features of different embodiments mentioned can be combined in additional embodiments. Consequently, the description and the drawings should be considered as illustrating rather than limiting.

1. A sound absorber extending between two opposite surfaces and comprising:
one or more first quarter-wave acoustic resonators each having a first length, substantially greater than a thickness of the sound absorber between the two opposite surfaces, between a first end, open on a first surface of the two opposite surfaces of the sound absorber, and a second, closed end, and a microporous element, consisting of a plurality of periodically repeating unit cells, adjacent to the first acoustic resonators.

2. The sound absorber according to claim 1, wherein the first quarter-wave acoustic resonators are inclined relative to a direction of the thickness of the sound absorber.

3. The sound absorber according to claim 2, wherein the first quarter-wave acoustic resonators are at least partially helical.

4. The sound absorber according to claim 1, wherein the first quarter-wave acoustic resonators are bent.

5. The sound absorber according to claim 1, wherein the microporous element comprises at least a first and a second superposed layer in the thickness of the sound absorber, and the unit cells constituting the first layer are different from the unit cells constituting the second layer.

6. The sound absorber according to claim 1, wherein each unit cell comprises a channel and/or intersecting strands.

7. The sound absorber according to claim 1, wherein the first quarter-wave acoustic resonators are disposed around the microporous element.

8. The sound absorber according to claim 1, comprising one or more second quarter-wave acoustic resonators each having a second length, substantially different from the first length.

9. The sound absorber according to claim 8, wherein the first acoustic resonators and the second acoustic resonators are disposed in adjacent rows.

10. The sound absorber according to claim 9, wherein the adjacent rows are concentric.

11. A gas turbine engine incorporating the sound absorber according to claim 1.

12. An aircraft incorporating the sound absorber according to claim 1.

13. A method for producing a sound absorber according to claim 1, comprising a step of additive manufacturing of the microporous element and/or of the quarter-wave acoustic resonators.

14. The production method according to claim 13, wherein the additive manufacturing step is carried out by depositing molten material.

15. The production method according to claim 14, wherein the molten material is deposited along a zig-zag path.

16. The production method according to claim 13, comprising a subsequent assembly step of the microporous element with the quarter-wave acoustic resonators.

17. The production method according to claim 16, wherein the assembly of the microporous element with the quarter-wave acoustic resonators is carried out by shrink fitting.
